(19) United States
(12) Patent Application Publication
(10) Pub. No.: US 2011/0058374 A1
(43) Pub. Date: Mar. 10, 2011

(54) LED illumination device capability of regulating angle of illumination

(76) Inventors: Yu Hsin Tsai, Sinjhuang City (TW); Yen Chi Wu, Sinjhuang City (TW); Meng Hsieh Chou, Sinjhuang City (TW)

(21) Appl. No.: 12/703,768

(22) Filed: Feb. 11, 2010

(30) Foreign Application Priority Data
Sep. 10, 2009 (TW) 098130480

(51) Int. Cl. F21V 21/14; F21V 21/02

(52) U.S. Cl. 362/249.11; 362/430

(57) ABSTRACT

An LED illumination device capability of regulating angle of illumination comprises a regulating unit and an LED illumination. The regulating unit has a fixed portion, a connection portion and a bend portion connected between the fixed portion and the connection portion. The LED illumination lamp is mounted on the connected portion of the regulating unit, then, the connection portion may regulated an angle relative to the fixed portion of the regulating unit by bending the bent portion of the regulating unit.

### FIELD OF THE INVENTION

The present invention relates to an LED illumination device capability of regulating angle of illumination, and in particular to an LED illumination device may be regulated illumination angle quickly.

### DESCRIPTION OF THE RELATED ART

Since light emitting diodes (LEDs) feature the high brightness, power saving and long life expectancy advantages, they have been used extensively for the illumination of lamps. Several LED lamps are usually connected to form an LED lamp set, and the position of each lamp can be adjusted to achieve an illumination effect to meet the requirements for a large projecting area and a high brightness. These LED lamp sets are used as illuminating devices indoors and outdoors. However, it is necessary to plan the LED lamps and the layout of different projecting areas, so as to differentiate the projecting area for each LED lamp with a different distance from the LED lamp and the projecting area and prevent an uneven brightness of the light projected from the LED lamps onto the projecting areas. Therefore, it is an important subject for manufacturers in the related field to design an LED lamp with good directionality and even brightness.

As is generally known in the art, use has been made of varying kinds of illumination lamps for lightening or illuminating objects at night or indoors. Such illumination lamps are supplied with electric energy from a power source and convert the electric energy to light energy, thereby producing a beam of light for illumination. Typical examples of the illumination lamps include a glow lamp and a fluorescent lamp.

Widely used in recent years is a Light Emitting Diode (LED) illumination lamp that has a benefit of providing illumination of different colors, although higher in price than the typical lamps referred to above. However, the LED illumination lamp poses a drawback in that it tends to be heated up and shows decreased efficiency when used for more than a predetermined time period. Use of the LED lamp for a prolonged period of time may result in excessive heat generation, thus shortening the life span of the lamp.

Please referring to FIG. 1, a conventional day light includes a base 10, two inclined surfaces 11 located on the base 10, two electrically connected head 12 arranged at the both side of the base 10 and two light tube 13 arranged at the inclined surface 11 of the base 10 respectively, so that it may regulated angle of illumination.

### SUMMARY OF INVENTION

An object of the present invention is to provide an LED illumination device capable of regulating angle of illumination.

To achieve the above-mentioned object, the present invention includes a regulating unit and an LED illumination. The regulating unit has a fixed portion, a connection portion and a bend portion connected between the fixed portion and the connection portion. The LED illumination lamp is mounted on the connected portion of the regulating unit, then, the connection portion may regulated an angle relative to the fixed portion of the regulating unit by bending the bent portion of the regulating unit.

### BRIEF DESCRIPTION OF THE DRAWINGS

FIG. 1 is an exposed view of conventional day light.

FIG. 2 is a scheduled of first preferred embodiment of present invention

FIG. 3 is a cross-sectional view of first preferred embodiment of the present invention.

FIG. 4 is a scheduled of second preferred embodiment of present invention

FIG. 5 is a cross-sectional view of second preferred embodiment of the present invention,

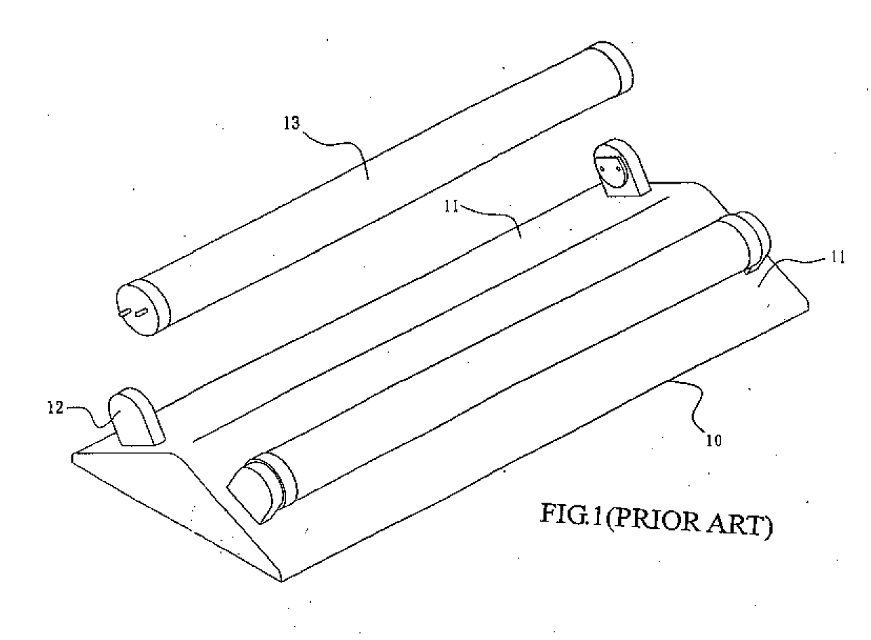

### DETAILED DESCRIPTION OF THE INVENTION

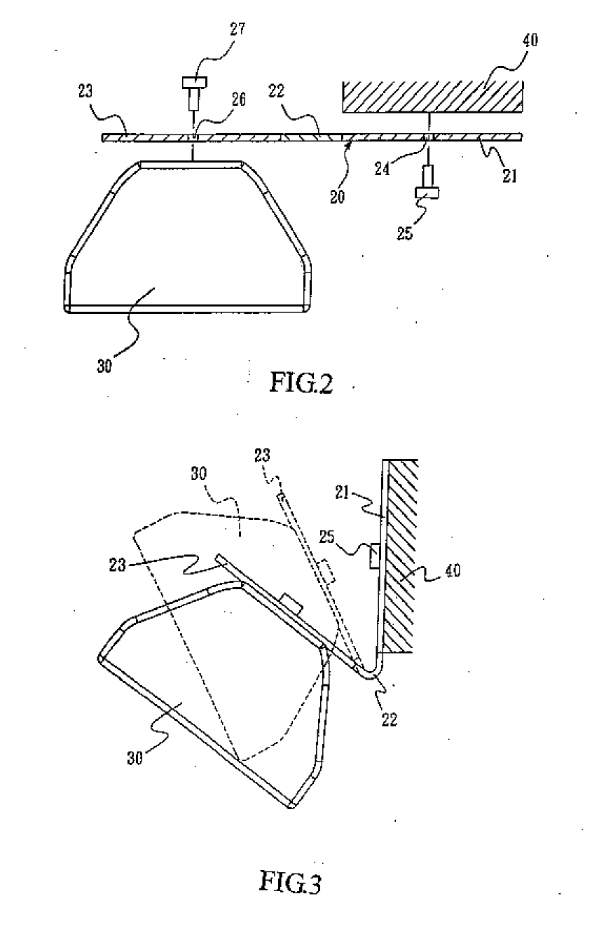

Referring to FIG. 2 and FIG. 3, an LED illumination device capability of regulating angle of illumination includes a regulating unit 20 mounted at a wall 40 and an LED illumination lamp 30. Wherein
The regulating unit 20 has a metal sheet, which is formed with a fixed portion 21 fixed on the wall 40, a connection portion 23 and a bend portion 22 connected between the fixed portion 21 and the connection portion 23. In the embodiment, the fixed portion 21 of the regulating unit 20 is formed with a first fixed hole 24, so that the fixed portion 21 may be fixed at the wall 40 via a first fixed element 25 inserted into the first fixed hole 24. The connection portion 23 of the regulating unit 20 is formed with second fixed hole 26. And
LED illumination lamp 30 is mounted on the connected portion 23 of the regulating unit 20 via second fixed element 27 insert into the second fixed hole 26 of the connection portion 23, then, the connection portion 23 may be regulated an angle relative to the fixed portion 21 of the regulating unit 20 by bending the bent portion 22 of the regulating unit.

Therefore, the LED illumination lamp 30 may be regulated illumination angle by bending the bend portion 22 of the regulating unit 20.

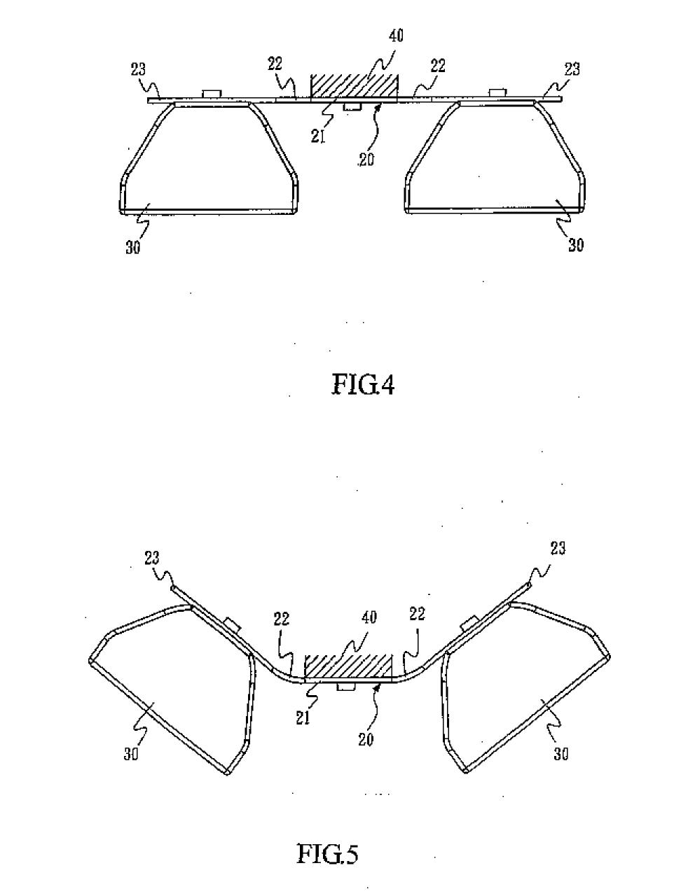

Referring to FIG. 4 and FIG. 5, the second preferred embodiment of the present invention includes a regulating unit 20 mounted at a wall 40 and two LED illumination lamp 30. Wherein
The regulating unit 20 has a metal sheet, which is formed with a fixed portion 21 fixed on the wall 40, two connection portion 23 and two bend portion 22 connected between the fixed portion 21 and the connection portion 23.
The two LED illumination lamp 30 is mounted on the two connected portion 23 of the regulating unit 20, then, the connection portion 23 may be regulated an angle relative to the fixed portion 21 of the regulating unit 20 by bending the bent portion 22 of the regulating unit.
Therefore, the two LED illumination lamps 30 may be regulated illumination angle by bending the two bend portion 22 of the regulating unit 20.
While the present has been described by way of an example and in terms of a preferred embodiment, it is to be understood that the invention is not limited to the disclosed embodiment. To the contrary, it is intended to cover various modifications. Therefore, the scope of the appended claims should be accorded the broadest interpretation so as to encompass all such modification.

What is claimed is:

1. An LED illumination device capability of regulating angle of illumination for positioning to a wall comprising
A regulating unit having a fixed portion fixed on the wall, a connection portion and a bend portion connected between the fixed portion and the connection portion; and
An LED illumination lamp mounted on the connection portion of the regulating unit, then, the connection portion may be regulated an angle relative to the fixed portion or the regulating unit by bending the bent portion or the regulating unit.

2. The LED illumination device capability of regulating angle of illumination according to claim 1, wherein the fixed portion of regulating unit is fixed on the wall via a first fixed element.

3. The LED illumination device capability of regulating angle of illumination according to claim 1, wherein the LED illumination lamp is mounted on the connected portion of regulating unit via a second fixed element.

4. The LED illumination device capability of regulating angle of illumination according to claim 1, wherein regulating unit has a metal sheet.

5. An LED illumination device capability of regulating angle of illumination for positioning to a wall comprising:
A regulating unit having a fixed portion fixed on the wall, two connection portion and two bend portion connected between the fixed portion and the two connection portion individually; and
Two LED illumination lamp mounted on correspond to the connected portion of the regulating unit, then, the two connection portion may regulated an angle relative to the axed portion of the regulating unit by bending the two bent portion of the regulating unit.
